(19) United States
(12) Patent Application Publication
(10) Pub. No.: US 2010/0228503 A1
(43) Pub. Date: Sep. 9, 2010

(54) Programmable Electronic Pressure Switch with Display

(75) Inventor: Adriana Sartor, Milano (IT)

Correspondence Address: AKERMAN SENTERFITT, P.O. BOX 3188, WEST PALM BEACH, FL, 33402-3188, US

(73) Assignee: Elettrotec S.r.l., Milano (IT)

(21) Appl. No.: 12/092,782

(22) PCT Filed: Nov. 2, 2006
(86) PCT No.: PCT/EP06/68040

§ 371 Date: May 6, 2008

(30) Foreign Application Priority Data
Nov. 8, 2005 (IT) MI2005A002122

(51) Int. Cl. G06F 19/00; G01L 7/00

(52) U.S. Cl. 702/50

(57) ABSTRACT

An electronic pressure switch is described comprising an external body (1) provided with a cavity (60) upperly closed by a lid (62) which supports a connector (6), in said cavity (60) being accommodated a pressure sensor (8) exposed to the monitored environment pressure, at least one circuit board (2-3) provided with memory connected to said pressure sensor (8) and a display (100) for displaying information useful to the operator and programming the pressure switch itself by means of setting means comprising at least one button (12-14). Said at least one circuit board (2-3) comprises circuit components (22, 25, 35, 49, 50) managed by an integrated software for setting at least one analogue output value (39-40) according to any pressure value measurable by the pressure sensor (8).

The present invention concerns a programmable electronic pressure switch with display.

There are known pressure switches comprising an external body with an internal cavity in which a circuit board is accommodated which is connected to a pressure sensor and to a power supply via a connector.

Said pressure switches also comprise buttons for setting some parameters which are preferably arranged within the cavity for better protection.

Italian patent application MI2004A002329, filed on Dec. 3, 2004, shows a pressure switch with two internal setting buttons which allow to set the intervention value and the reset value, present at digital outputs, according to the pressure status of the system to which said pressure switch is connected.

There are also pressure switches which comprise for a display with setting buttons which allow navigating in configuration menus managed by a software integrated in the circuit board comprised in the pressure switch.

Furthermore, said pressure switches may have analogue outputs thus defined: a low output (e.g. 4 mA) equivalent to no pressure, and a high output (e.g. 20 mA) equivalent to the maximum pressure withstandable by the system (full-scale of the pressure gauge). An intermediate output proportional to the detected pressure is available for intermediate values.

Said analogue output signals may be used for measurement instruments, valve control and so on.

It is the object of the present invention to make a pressure detecting pressure switch which can be programmed so as to vary the output levels corresponding to the detected pressures, in particular allowing to vary the pressure which determines the high level analogue output.

According to invention, this object is reached by an electronic pressure switch comprising an external body provided with a cavity upperly closed by a lid which supports a connector, a pressure sensor exposed to the pressure of the monitored environment being accommodated in said cavity, at least one circuit board provided with memory connected to said pressure sensor and a display for viewing useful information for the operator and programming the pressure switch itself by means of setting means comprising at least one button, characterised in that said at least one circuit board comprises circuit components managed by an integrated software for setting at least one analogue output value according to any pressure value measurable by the pressure sensor.

The possibility of setting the high level analogue output as desired according to the pressure allows to control valves, to provide signals to measurement instruments and more. In essence, the pressure switch according to the present invention may interface with any machine without the interposition of signal transformation devices.

These and other features of the present invention will be further explained in the following detailed description of an embodiment thereof shown by way of non-limitative example in the attached drawings, in which:

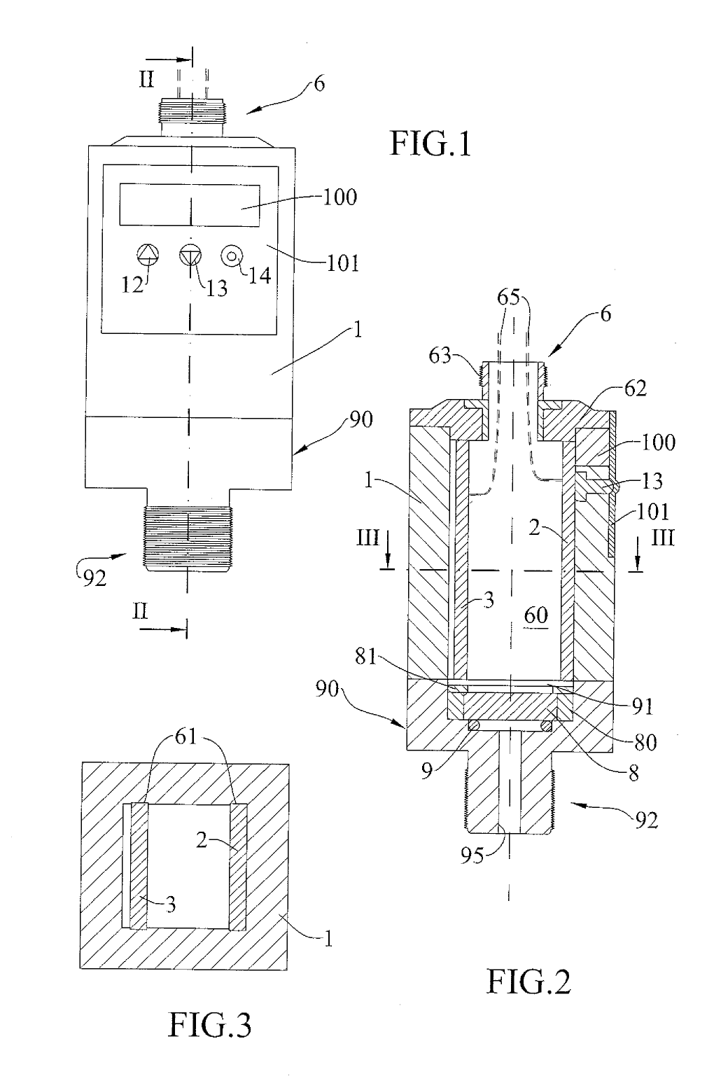

FIG. 1 shows a frontal view of a pressure switch according to the present invention;

FIG. 2 shows a sectional view taken along line II-II in FIG. 1;

FIG. 3 shows a sectional view taken along line III-III in FIG. 2;

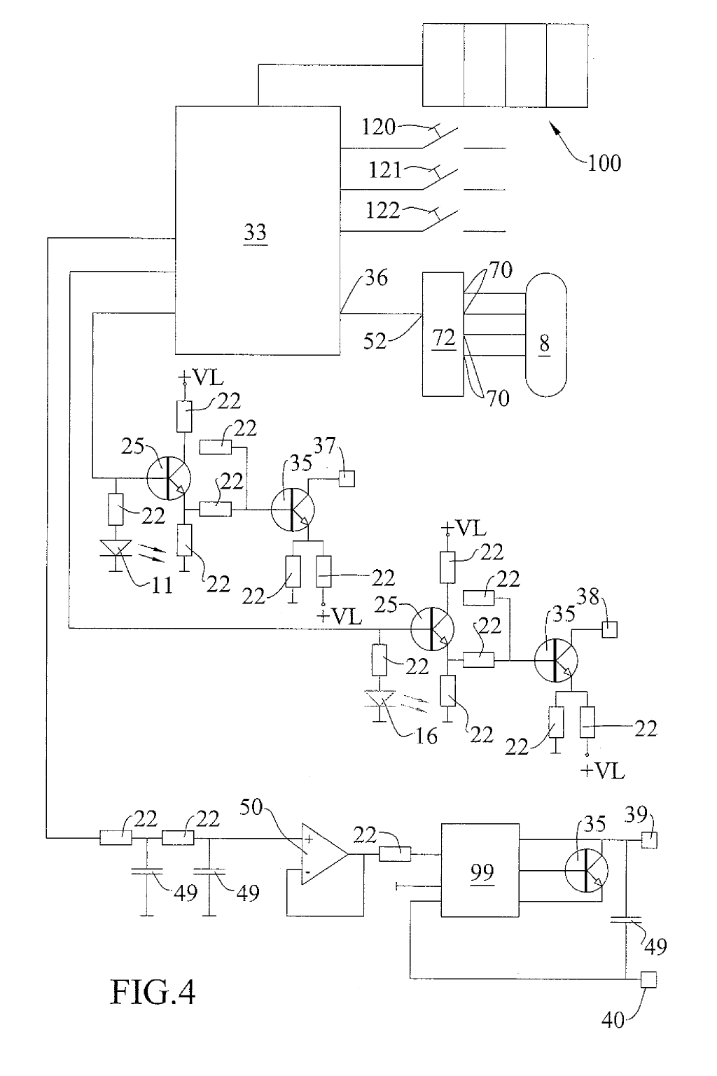

FIG. 4 shows a circuit comprised in said at least one circuit board.

The electronic pressure switch shown in FIGS. 1 and 2 comprises an external aluminium body 1 with a cavity 60 having two pairs of longitudinal grooves 61 removably engageable with the ends of flat extractable circuit boards 2-3, electrically connected to each other.

Said cavity 60 is upperly closed by a lid (62) which supports a connector 6 with external threading 63, crossed by electrical wires 65 for the external electrical connection of circuit boards 2-3.

External board 1 supports a LED display 100 and setting buttons 12-14, said display and said buttons being protected by a membrane 101.

On the lower part of body 1 a steel flange 90 is fixed which is provided with a cavity 91 in which a ceramic pad pressure sensor 8 with respective seal 9 is fixed by means of a ring nut 80 and a spacer 81, underneath which cavity a threaded attachment 92 for connecting to the pressurised circuit to be monitored, with an internal input channel 95 for the monitored fluid, is found.

Said flange 90 is releasable from body 1, and in general is made of more resistant material with respect to body 1 in order to work at very high working pressures. It may also be replaced by another flange of different material variable according to the required working pressure.

From a circuit point of view, said boards 2-3 comprise as a whole a circuit of the type shown in FIG. 4 having switches 120-122 respectively controlled by setting buttons 12-14, a microprocessor 33 with internal E2PROM, switching transistors 25, power transistors 35, various resistors 22, capacitors 49, an amplifier 50, ground connections, analogue outputs 39-40 controlled by a further regulation board 99, and digital outputs 37-38 with indicator LEDs 11 and 16.

The circuit further comprises a Wheatstone bridge 72 to which the ceramic pad 8 is connected, with inputs 70 and an output 52 connected to an input 36 of microprocessor 33.

FIG. 4 further shows a LED display 100 connected to microprocessor 33.

The management of information contained in the pressure switch and the manual setting are rather simple operations being based on the use of buttons 12-14 and on visualisation by means of display 100.

It is assumed that the pressure switch is fitted in the monitored system or machine with intervention pressure (e.g. 7 bars) taken to the required running value. Such pressure is detected by ceramic sensor 8, which determines an umbalance of Wheatstone bridge 72 which is translated into an electrical signal of amplitude corresponding to the detected pressure, existing on output 52 of Wheatstone bridge 72 and on input 36 of microprocessor 33 of circuit 17 in FIG. 3.

Said detected pressure may be shown on display 100.

By navigating by means of setting buttons 12-14 in configuration menu managed by a software integrated in boards 2-3 and visible by means of display 100, it is possible to program:
the intervention values;
the engineering unit;
the delay time of outputs 37-40;
the intervention point;
the reset point with or without pressure.

In particular, buttons 12-13 are used to scroll the menus up and down, button 14 is used to access the submenus and more in general to provide input signals. The navigation system is similar to that of a cellular telephone. The menus are essentially “tree”-structured: the buttons are used to reach the required “branch”.

It is not necessary to stop the monitored pressurised system or machine to perform these settings. The presence of power in the pressure switch is indicated on display 100.

Each acquisition of a new intervention value also automatically sets the reset threshold (hysteresis) according to a minimum hysteresis value.

As previously mentioned, the pressure switch presents digital outputs 37-38 and analogue current outputs 39-40 (which may also be voltage outputs).

Of the various settings, the basic, and possibly the most useful, setting allows to set output signals according to the detected pressure. Usually, a first output is associated to zero pressure (no pressure) value and a second output is associated to maximum pressure (full-scale of the pressure gauge) value.

For example, by setting a digital output 37-38, display 100 will light up with red light (red LED 11) if the output is “1” (zero pressure) and green light if the output is “0” (full-scale). Obviously, the signals may be reversed.

If an analogue output is set, a low current output 40 can be set (e.g. 4 mA) in the event of no pressure and a high output 39 (e.g. 20 mA) can be set for the full-scale.

An essential innovation made possible by the presence of display 100 and buttons 12-14, as well as by the management software used, consists in the possibility of setting at all times the pressure value other than zero which determines the presence of the high voltage value on analogue output. This means that a high signal (20 mA) can be obtained also for low pressure values, said high signal being very important for the operation of various measurement instruments or for controlling valves or other instruments.

As already pointed out in the preamble to the present patent, the current pressure switches allow to associate the high value (20 mA) to the full-scale, the intermediate pressures being indicated by signals proportionally lower and not suitable for the purpose for which they are used.

Board 99 of the circuit in FIG. 4 indeed allows to set high output 39 to different pressure values.

The pressure switch here described may be provided with means for allowing remote information display and programming. In complex systems in which several pressure switches are fitted, the pressure switch can be identified from a remote control position and its operation.

Setting buttons 12-14 may be used to introduce programming lock/unlock codes. The operator can perform setting operations only if the programmed combination of buttons 12-13 is known (e.g. button 12 is pressed twice, button 13 is pressed once and then button 14 is pressed three times). Such code is managed by a software integrated in circuit boards 2-3.

The pressure switch according to the present invention thus allows to work in total safety (it has a high resistance to pressure surges and overpressure) and to rapidly set various parameters easily visible by means of display 100.

1. An electronic pressure switch comprising an external body provided with a cavity wherein there are accommodated a pressure sensor arranged under pressure of the monitored environment and adapted to detect pressure values between a minimum pressure value and a maximum pressure value, at least one circuit board provided with memory connected to said pressure sensor and a display for viewing information for an operator and programming the pressure switch itself by means of setting means comprising at least one button, said at least one circuit board comprising circuit components controlled by an integrated software application, wherein said integrated software application is adapted to set at least a first and a second analog output values with the second analogue output value higher than the first analog output value and wherein the first analog output value is set according to the minimum pressure value, the second analog output value is set according to any pressure value measurable by the pressure sensor, comprised between the minimum and the maximum pressure values except the same minimum pressure value, and in that said cavity being closed by a lid which supports a connector.

2. A pressure switch according to claim 1, wherein the pressure switch further comprises a digital output adapted to provide a digital signal when a programmed pressure value is reached.

3. A pressure switch according to claim 1, wherein said circuit components comprise a regulation board, settable by means of said setting means, adapted to receive a signal from a microprocessor and emit a digital output signal and an analog output signal according to the received signal.

4. A pressure switch according to claim 3, wherein said microprocessor is controlled by said setting means and is provided with a memory which stores a signal from a Wheatstone bridge according to pressure detected by the sensor, said microprocessor determining the presence or not of an output signal as a function of said signal stored in the memory, the output signal being the digital and/or the analog output signal.

5. A pressure switch according to claim 1, wherein said at least one circuit board comprises a software for displaying menus for reading information and configuring the pressure switch on the display, said menus being navigable with said at least one button.

6. A pressure switch according to claim 5, wherein the pressure switch comprises a first and a second buttons for scrolling said menu and a third setting button.

7. A pressure switch according to claim 1, wherein the pressure switch allows the operator to set the pressure value for which a high analog output signal is provided.

8. A pressure switch according to claim 1, wherein said display is a LED display.

9. A pressure switch according to claim 1, wherein the pressure switch comprises an external membrane for protecting the display and at least one button.

10. A pressure switch according to claim 1, wherein the pressure switch comprises two circuit boards.

11. A pressure switch according to claim 1, wherein the pressure switch comprises a removable lower flange for attaching to the pressurized environment to be monitored.
